(19) United States
(12) Patent Application Publication
(10) Pub. No.: US 2026/0179278 A1
(43) Pub. Date: Jun. 25, 2026

(54) SYSTEM FOR AUTOMATED SLIDE LAYOUT DESIGN

(71) Applicant: Microsoft Technology Licensing, LLC, Redmond, WA (US)

(72) Inventors: Brooke Trimble BEHRBAUM, San Francisco, CA (US); Kavyashree KEELARA SHIVALINGAIAH, Menlo Park, CA (US); Alana BRITO ALVES DA SILVA, San Francisco, CA (US); Daniel Ming-Wei CHEUNG, San Francisco, CA (US); Sushma JAYASHANKARA, Fremont, CA (US); Onur ONDER, San Jose, CA (US)

(21) Appl. No.: 19/000,276

(22) Filed: Dec. 23, 2024

(51) Int. Cl. G06T 11/60

(52) U.S. Cl. CPC G06T 11/60

(57) ABSTRACT

Systems, methods, and software are disclosed herein for automated slide design and generation for slide presentations. In an implementation, a computing apparatus receives suggested content to present in a new slide of a presentation document having a theme defined by a template associated with the presentation document; generate a new layout in accordance with which to present the suggested content in the new slide based on an existing layout of the template; and merge the suggested content with the new layout to generate the new slide.

### TECHNICAL FIELD

Aspects of the disclosure are related to the field of software applications for creating slide presentations including custom slide design.

### BACKGROUND

Productivity applications for creating slide presentations facilitate unity in design by providing templates to style the presentation. When applied to a slide presentation, a template ensures that all the slides in a presentation have a consistent visual style, including consistent use of fonts, colors, background designs, and effects. Templates may also incorporate corporate or organizational branding elements such as logos, specific color schemes, and fonts to ensure brand consistency across all presentations. Ultimately, templates will give a slide presentation a polished and professional appearance.

Users can design custom templates, such as a custom template for an organization, but this can be a time-consuming endeavor that depends on facility with the presentation application. To design a custom template, the user designs a slide master of recurring elements that will be common to all of the slide layouts in the template and multiple slide layouts for presenting different types of content. The slide master may include a background design, font styles for the different kinds of text content, and a color scheme or palette for the visual elements of the slide. The custom template may include many different kinds of slide layouts, such as layouts for title slides, content slides, and transitional slides like blank slides, section headers, and closing slides. Each slide layout includes an arrangement of placeholders depending on the role of the slide or the type of information the slide presents. As such, building a high-quality custom template can be a time-consuming task, with the user having to design not just a slide master but also several slide layouts. Typically, however, the user designs as many slide layouts as are needed and adds more layouts as the need arises. Building a template in this way runs the risk that the quality and consistency of the template will start to decline.

### OVERVIEW

Technology is disclosed herein for automated slide design and generation for slide presentations. In an implementation, a computing apparatus comprising one or more computer readable storage media, one or more processors operatively coupled with the one or more computer readable storage media, and program instructions stored on the one or more computer readable storage media that, when executed by the one or more processors, direct the computing apparatus to receive suggested content to present in a new slide of a presentation document having a theme defined by a template associated with the presentation document; generate a new layout in accordance with which to present the suggested content in the new slide based on an existing layout of the template; and merge the suggested content with the new layout to generate the new slide.

In another example, a method of operating a computing apparatus comprises receiving suggested content to present in a new slide of a presentation document having a theme defined by a template associated with the presentation document; generating a new layout in accordance with which to present the suggested content in the new slide based on an existing layout of the template; and merging the suggested content with the new layout to generate the new slide.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for automated slide layout design and generation in an implementation.

FIG. 2 illustrates a process for automated slide layout design and generation in an implementation.

FIG. 3 illustrates an operational environment for automated slide layout design and generation in an implementation.

FIG. 4 illustrates a workflow for automated slide layout design and generation in an implementation.

FIG. 5 illustrates a workflow for automated slide layout design and generation in an implementation.

FIG. 6 illustrates a computing system suitable for implementing the various operational environments, architectures, processes, scenarios, and sequences discussed below with respect to the other Figures.

### DETAILED DESCRIPTION

Various implementations are disclosed herein for generating custom slide layouts for slide presentations based on the slide content and in accordance with the theme of the presentation. In an illustrative scenario, a user prompts a presentation application, such as Microsoft PowerPoint, to generate a slide deck which will incorporate a custom template, such as a template created by the user or by the user's organization. For example, the user may submit a natural language input to an application assistant for content generation to receive a slide presentation. The custom template for the presentation may include a variety of slide layouts for arranging different types of content (e.g., text, image) and which are visually unified by a visual theme. The application assistant, such as an AI service or functionality for content generation, creates content for the slide presentation which may include text, images, and other types of content. A design service of the application formats the slides for the slide content by selecting layouts from the custom template for each slide according to its content and applying the selected layouts to the slides. For example, a title slide layout of the custom template may be applied to title slide content to generate the title slide of the presentation.

Continuing with the illustrative scenario, because the custom template may include a limited variety of slide layouts, if an appropriate layout is not available for the content of a given slide from among the existing layouts, the design service generates a new layout for the slide that is appropriately structured (e.g., includes the correct number of appropriate placeholders) for the slide's content by modifying an existing layout in the template (that is to say, duplicating an existing layout and modifying the duplicate). The layout generated by the design service will be structured to receive the content of the slide, including placeholders for the elements of the content, such as text, image, video, audio, chart, table, or other types of content. The design service then merges the slide content with the new layout to create the slide and returns the slide presentation with the newly generated slide to the application. Thus, the process of generating a slide presentation can be completed even with a template with a limited set of slide layouts. Moreover, the process of generating a fully designed slide presentation can be completed in a manner which is transparent to the user.

In an implementation, the design service is a functionality of a presentation application which receives slide content, such as a PPTX file or other container of slide content, and an existing layout of a selected template and creates a new layout for the slide content by adapting or modifying an existing layout for the slide content, i.e., for the particular elements of the slide content (e.g., title, text, image). To modify the existing layout to create the new layout, the design service applies design rules for modifying the layout, such as adding placeholders, removing placeholders, changing the type of a placeholder (e.g., from image to text), moving placeholders around, and so on, but also adhering to design choices with respect to font properties, spacing, graphical elements, and so on.

In various implementations, to generate a custom layout for slide content, the design service first analyzes the existing slide layouts of the template in use to determine if a suitable layout is available. If an existing layout is provided in the template which has the appropriate structure for the slide content, then the design service creates the slide by merging the slide content with the existing layout. However, because the application assistant may generate slide content for a layout which is not in the template, the design service can create such a layout in real-time. For example, the suggested content of a slide in the presentation may have a title element, two text elements, and an image element, but the template may not have an existing layout with placeholders which are structured for the number and types of elements of the slide content. Upon determining that a suitable layout is not available in the template, the design service generates a new slide layout modeled after an existing slide layout, thus ensuring that the new layout is consistent with the theme of the template. The slide layout selected to be the base layout for the new slide blueprint may include a basic set of placeholders, such as a title placeholder and one or two content placeholders. In some scenarios, one or more of the existing layouts are identified as base layouts for generating new layouts for the slide content. The new layouts are generated by duplicating the base layouts and then modifying the duplicated layouts. Modifications to the duplicated layouts are made according to the suggested content for the slide and rules or instructions for modifying the duplicate base layout to generate the new layout. The slide content is then merged with each of the base layouts and the newly generated layouts to create suggestions (i.e., suggested slides which are complete with content and layout). The suggestions demonstrate different ways the slide content could be presented. The suggestions are then ranked or ordered (for example, by a ranking algorithm executed by the application or design service or by an AI model) to determine the best slide for presenting the slide content.

When a new layout is generated for the slide content, the design service merges the content of the slide with the layout to create the new slide. The design service may add recurring or global design elements from the template to the new slide. For example, the template may include a slide master with recurring or global design elements which are applied to all the slides in the presentation such as text formatting information, a background design, a color scheme, logos, slide numbering, etc. When the content is merged into the new layout to create the slide and the slide presentation is complete, the application surfaces the slide presentation in the user interface. In the user interface, the user may elect to store the newly designed slide layout in the template for future use. In some scenarios, the application may add new slide layouts to the template automatically.

In various implementations, the suggested content for a slide presentation is generated by an application assistant of the presentation application in response to a natural language request from the user, such as a request received in a chat interface. The application assistant may be an AI service of the application, such as one which communicates with or includes a generative AI model for content creation. The application assistant may create content for the presentation and return the content encoded in XML or in a PPTX file. In some cases, the application assistant may create the slide content for a presentation based on a document provided by the user, such as a report in a word processing document.

In some scenarios incorporating the technology disclosed herein, the user manually creates content for a slide deck. If the user's selected template, such as a custom template created by the user or an organization, lacks an appropriate layout for one of the user's slides, the design service may automatically generate a new layout for the slide with a structure determined based on the content elements in the slide, ensuring that the slide layout is consistent in design with the user's selected template.

In still other scenarios implementing the technology disclosed herein, the application may analyze a custom template to determine if one or more new slide layouts should be added to the template to produce a more complete or comprehensive set of layouts for the template. For example, the application may compare the layouts of a custom template against a core set of layouts to identify missing layouts. The core set of layouts may be, for example, a set of layouts which an AI-powered application assistant references in generating slide content. The design service, upon determining that the template lacks the desired layouts, then generates the missing layouts to complete the template.

Generative AI models of the technology disclosed herein include large-scale foundation models trained on massive quantities of diverse, unlabeled data using self-supervised, semi-supervised, or unsupervised learning techniques. Such models may be based on a number of different architectures, such as generative adversarial networks (GANs), variational auto-encoders (VAEs), and transformer models, including multimodal transformer models. Foundation models capture general knowledge, semantic representations, and patterns and regularities in or from the data, making them capable of performing a wide range of downstream tasks. Foundation models include BERT (Bidirectional Encoder Representations from Transformers) and ResNet (Residual Neural Network). In some scenarios, a foundation model may be fine-tuned for specific downstream tasks. Fine-tuning a foundation model involves adjusting the parameters of the pretrained model according to a specific dataset to adapt the model's output to a particular task. Types of foundation models may be broadly classified as or include pre-trained models, base models, and knowledge models, depending on the particular characteristics or usage of the model. Foundation models may be multimodal or unimodal depending on the modality of the inputs.

Multimodal models are a class of foundation model which extend their pre-trained knowledge and representation capabilities to handle multimodal data, such as text, image, video, and audio data. Multimodal models may leverage techniques like attention mechanisms and shared encoders to fuse information from different modalities and create joint representations. Learning joint representations across different modalities enables multimodal models to generate multimodal outputs that are coherent, diverse, expressive, and contextually rich. For example, multimodal models can generate a caption or textual description of the given image by extracting visual features using an image encoder, then feeding the visual features to a language decoder to generate a descriptive caption. Similarly, multimodal models can generate an image based on a text description (or, in some scenarios, a spoken description transcribed by a speech-to-text engine). Multimodal models include visual-language foundation models, such as CLIP (Contrastive Language-Image Pre-training), ALIGN (A Large-scale ImaGe and Noisy-text embedding), and ViLBERT (Visual-and-Language BERT), for computer vision tasks. Examples of visual multimodal or foundation models include DALL-E, DALL-E 2, Flamingo, Florence, and NOOR. Types of multimodal models may be broadly classified as or include cross-modal models, multimodal fusion models, and audio-visual models, depending on the particular characteristics or usage of the model.

Large language models (LLMs) are a type of foundation model which processes and generates natural language text. These models are trained on massive amounts of text data and learn to generate coherent and contextually relevant responses given a prompt or input text. LLMs are capable of understanding and generating sophisticated language based on their trained capacity to capture intricate patterns, semantics and contextual dependencies in textual data. In some scenarios, LLMs may incorporate additional modalities, such as combining images or audio input along with textual input to generate multimodal outputs. Types of LLMs include language generation models, language understanding models, and transformer models.

Transformer models, including transformer-type foundation models and transformer-type LLMs, are a class of deep learning models used in natural language processing (NLP). Transformer models are based on a neural network architecture which uses self-attention mechanisms to process input data and capture contextual relationships between words in a sentence or text passage. Transformer models weigh the importance of different words in a sequence, allowing them to capture long-range dependencies and relationships between words. GPT (Generative Pre-trained Transformer) models, BERT (Bidirectional Encoder Representations from Transformer) models, ERNIE (Enhanced Representation through kNowledge IntEgration) models, T5 (Text-to-Text Transfer Transformer), and XLNet models are types of transformer models which have been pretrained on large amounts of text data using a self-supervised learning technique called masked language modeling. Such pretraining allows the models to learn a rich representation of language that can be fine-tuned for specific NLP tasks, such as text generation, language translation, or sentiment analysis.

Technical effects of the technology disclosed herein include faster convergence to a desirable outcome which in turn reduces compute costs (e.g., processor usage, time). For example, to manual create a new slide layout, the user may duplicate an existing slide layout, then modify the layout according to the slide content. The manual editing can be a time-consuming process which introduces opportunities for human error, inconsistencies, and suboptimal design choices. Moreover, the process of manually editing a slide layout assumes that the user knows not only how to edit a slide layout but what the slide layout should look like for his/her content. For these reasons, manual editing is often a process of trial and error, with the user having to tweak the design until the desired outcome is achieved. Thus, manual editing can be time consuming and laborious, thereby negatively impacting the user experience.

Technical effects also include a functionality by which a slide presentation can be created based on a custom template of slide blueprints or layouts, but which can adapt or build on the existing layouts to create new layouts on the fly while maintaining the design aesthetic of the template. Automating slide layout generation in real time based on duplicating and modifying existing slides improves the user experience, allowing the user to focus on the important, substantive choices and leaving the lower-level details of generating the slides to the application. Thus, with AI-generated content provided by an application assistant or content generated in other ways, a presentation application can generate a complete slide presentation which includes a variety of slide types or designs but which maintains visual continuity and consistency in design throughout the presentation.

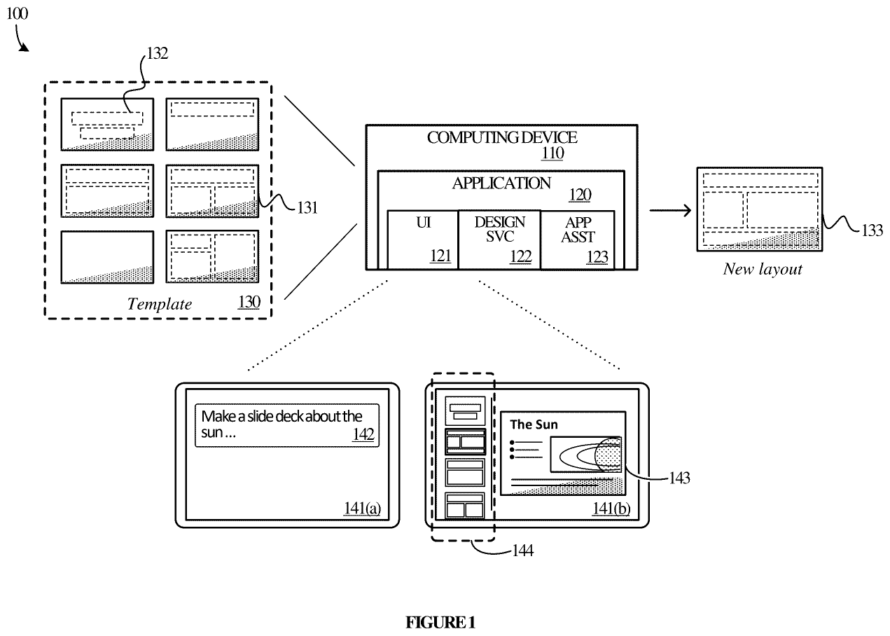

Turning now to the Figures, FIG. 1 illustrates operational environment 100 for automated design and generation of slide layouts for presentation applications in an implementation. Operational environment 100 includes computing device 110 and application 120. Application 120 includes user interface (UI) 121 displaying user experiences 141(a) and 141(b) and design service 122, design service 122, and application assistant 123. User experience 141(a) includes user input 142. User experience 141(b) includes slide 143 and slide presentation 144. Operational environment 100 also includes template 130 including multiple slide layouts such as layout 131. Various layouts of template 130 include placeholders (in broken line) such as placeholder 132. Operational environment 100 also includes new layout 133.

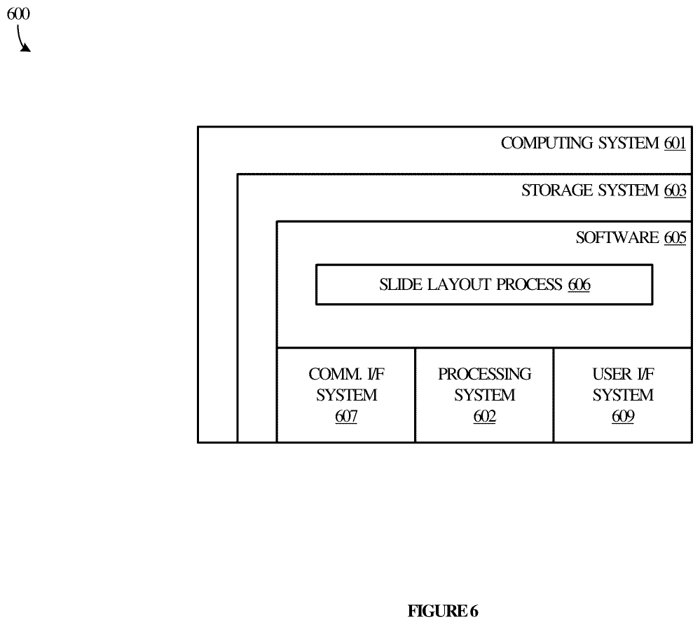

Computing device 110 is representative of a computing device, such as a laptop or desktop computer, or mobile computing device, such as a tablet computer or cellular phone, of which computing system 601 in FIG. 6 is broadly representative. Computing device 110 communicates with application 120 via one or more internets and intranets, the Internet, wired or wireless networks, local area networks (LANs), wide area networks (WANs), and any other type of network or combination thereof. A user interacts with application 120 via user interface 121 displayed on computing device 110. User experiences 141(a) and 141(b) displayed on computing device 110 are representative of user experiences of an environment hosted by application 120 in an implementation.

Application 120 is representative of a software application for creating and editing slides for slide presentations or slide decks, such as slide presentation 144 illustrated in user experience 141(b). Application 120 may be a presentation application, such as Microsoft® PowerPoint®, Apple® Keynote®, or Google® Slides, but may also be another type of productivity application which provides functionality for slide creation or the creation of other types of documents which include content elements arranged in structured layouts. Application 120 may execute locally on a user computing device, such as computing device 110, or application 120 may execute on one or more servers in communication with computing device 110 over one or more wired or wireless connections, causing user experiences 141(a) and 141(b) to be displayed in user interface 121 on computing device 110. In some scenarios, application 120 may execute in a distributed fashion, with a combination of client-side and server-side processes, services, and sub-services. For example, the core logic of application 120 may execute on a remote server system with user interface 121 displayed on a client device. In still other scenarios, computing device 110 is a server computing device, such as an application server, capable of displaying user interface 121, and application 120 executes locally with respect to computing device 110.

Application 120 executing locally with respect to computing device 110 may execute in a stand-alone manner, within the context of another application such as a browser application, or in some other manner entirely. In an implementation, application 120 hosted by a remote application service runs locally with respect to computing device 110 as a natively installed and executed application, a browser-based application, a mobile application, a streamed application, or any other type of application. Application 120 running locally with respect to computing device 110 may interface with the remote application service and provide local user experiences such as user experiences 141(a) and 141(b) displayed in user interface 121 on computing device 110.

In user interface 121, user experiences 141(a) and 141(b) are representative of a local user experience hosted by application 120 in an implementation. In user experience 141(a), application assistant 123 receives user input 142 (e.g., keyed in or translated to text by a speech-to-text engine) from a user. Slide 143 displays output generated by application assistant 123 in response to user input 142 with a custom layout generated by design service 122.

Design service 122 of application 120 is representative of a functionality of application 120 for designing slide presentations based on a template, such as template 130. For example, design service 122 may surface suggestions for slide designs to a user as the user is creating a slide in user interface 121. Design service 122 may apply slide layouts of a user-selected template to a slide presentation hosted by application 120 and generate new slide layouts for presenting slide content. For example, design service 122 may receive slide content from application assistant 123 and apply slide layouts of template 130 to generate a slide presentation. In some implementations, design service 122 includes functionality for generating new or custom slide blueprints or layouts based on an existing template of layouts, then merging slide content with the newly created layouts to create new slides.

Application assistant 123 of application 120 is representative of a functionality by which application 120 interfaces with a generative AI model (not shown) for prompting the model to generate or suggest slide content, such as text or imagery, for a slide presentation. For example, a user can request a slide presentation on a given topic by submitting a natural language query, keyed in or spoken, in a chat pane of application assistant 123 and receive output from the generative AI model which is responsive to the user's query. Application assistant 123 may be a service which interacts with an API of a generative AI model to transmit prompts to a generative AI model and to receive output generated by the model in response to the prompts. Application assistant 123 may interact with design service 122 to generate slide presentations, such as providing suggested content to design service 122 which design service 122 merges into slide layouts to generate a slide presentation.

Template 130 is representative of a library of layouts, such as layout 131, which have common theme for visual consistency. A theme of a template such as template 130 can include a predefined set of design elements and formatting rules that determine the visual appearance of slides to which a template is applied. Design elements of a theme can include a predefined palette of colors, selected fonts or typography, one or more background designs, graphical accents, and other visual effects. Formatting rules determine a consistent application of design elements such as rules which specify font sizes, text alignment or justification, color usage (e.g., as applied to text elements or graphical elements), and spacing (e.g., placeholder spacing, line spacing, kerning, and so on). A theme may be defined for multiple layouts of a template (e.g., the layouts of template 130) by providing formatting rules or design elements that are applied globally but may also include rules or elements that are specific to individual layouts. Template 130 may include a slide master (not shown) including design elements which are thematic or global to the slide layouts of template 130, such as a background design, a color scheme, a font scheme, graphics such as icons and logos, header/footer information, and so on.

Layout 131 of template 130 is representative of a slide layout which includes a structure or arrangement of placeholders, such as placeholder 132, for presenting different types of slide content. Slide layouts can include formatting (e.g., content formatting information), positioning (e.g., content positioning information), and placeholder boxes for the content that appears on a slide. The structure of a slide layout such as layout 131 may specify the number of placeholders, the types of placeholders (e.g., type of content which will be added to the placeholder), and the positions and proportions of the placeholders in the layout. Layouts such as layout 131 may also include rules which specify the positions of the placeholders relative to each other. Slide layouts of template 130 may include design elements such as dividers (e.g., bars, lines) and icons. Layout 131 may also indicate a particular purpose or role in a presentation, such as a title slide layout, an agenda slide layout, a closing slide layout, etc.

Placeholder 132 of layout 131 is representative of a placeholder or container of a slide layout for holding slide content such as text, images, videos, and the like. Placeholders, such as placeholder 132, designate areas in slide layouts for holding specific types of content. Types of placeholder content of a slide layout include text (e.g., titles, subtitles, body text, lists, captions, header/footer information), images, graphics, charts, tables, multimedia elements (e.g., audio clips, video clips), cameos, and so on. Placeholders of the layouts in template 130 may include formatting information, such as font or text formatting attributes, depending on the content held by the placeholder on the slide (e.g., a title placeholder may specify a larger font size) and the theme of template 130.

A brief operational scenario of operational environment 100 follows. A user of computing device 110 interacts with application 120 via user interface 121. As illustrated in user experience 141(a), the user has entered user input 142 which includes a natural language request for a slide presentation about a particular topic (as illustrated, the sun). For example, user input 142 may be entered in a chat interface of application assistant 123 of application 120. Application assistant 123 may be an AI-powered service of application 120 which interacts with a generative AI model (not shown) to obtain custom content generated in response to a user request such as user input 142. In some scenarios, the user selects template 130 for the slide presentation, but template 130 may be a default template applied automatically.

Upon receiving user input 142, application assistant 123 produces slide content for a slide presentation based on prompting a generative AI model to suggest slide content based on user input 142. The suggested content generated in response to user input 142 may include, for each slide, content elements such as titles, subtitles, other kinds of text such as bulleted lists, images, audio/video clips, and so on. Application assistant 123 engages design service 122 to generate the slides of the slide presentation by searching the layouts of template 130 and identifying a layout with which to present the suggested content of each slide. For example, if the suggested content includes a title element, a text element, and an image element, design service 122 selects a layout which includes placeholders corresponding to those particular types of slide elements.

Continuing with the operational scenario, when a layout is not present in template 130 for the suggested content of a slide, design service 122 generates a new slide layout that includes a structure that will accommodate the slide content. New layout 133 is generated by design service 122 based on the suggested content of the slide and a base or seed layout selected from template 130 that serves as a foundation for the new layout. Providing a base or seed layout enables design service 122 to maintain consistency in design between new layout 133 and the other layouts of template 130. In an implementation, to generate new layout 133, design service 122 executes an algorithm for modifying an existing layout to create a new layout. In some cases, design service 122 generates multiple new layouts (e.g., by modifying duplicates of multiple existing layouts), then selects a particular layout for use based on ranking the newly created layouts. The ranking of the newly created layouts is based on merging the slide content with each layout and evaluating the layouts with the merged content. In addition to generating the new layout based on the suggested content, the algorithm may also design the new layout based on information relating to the theme of template 130 including color scheme, font, and other theme-related design elements. Upon generating new layout 133, design service 122 may apply the global design or thematic elements of a slide master of template 130 to new layout 133, such as a background design element or slide numbering, to maintain consistency in design with the other slides in the presentation.

Design service 122 continues the process of generating the slide presentation by merging the selected and newly generated layouts with the suggested content to produce fully designed slide presentation 144. Application 120 surfaces slide presentation 144 generated in response to user input 142 in user experience 141(b). User experience 141(b) also depicts slide 143 which was created based on merging new layout 133 with the suggested content generated for the slide.

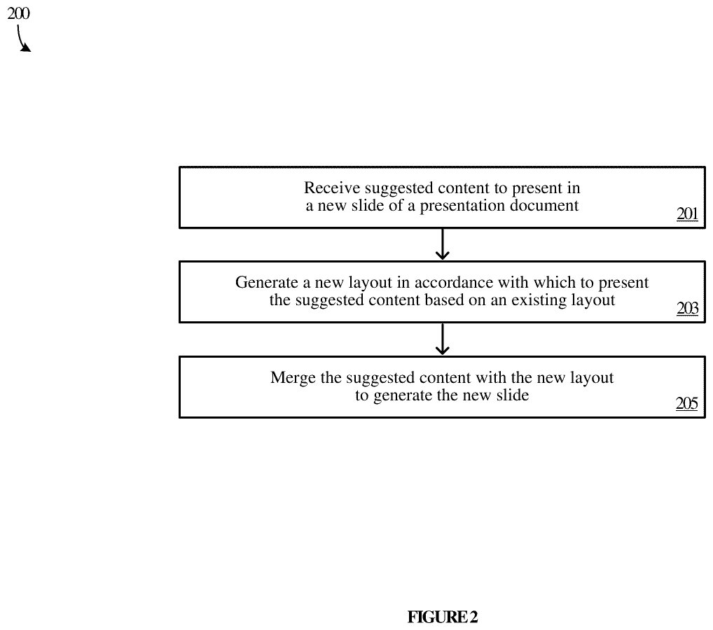

Turning now to FIG. 2, FIG. 2 illustrates a method for automated design and generation of slide layouts for presentation applications in an implementation, herein referred to as process 200. Process 200 may be implemented in program instructions in the context of any of the software applications, modules, components, or other such elements of one or more computing devices. The program instructions direct the computing device(s) to operate as follows, referred to in the singular for the sake of clarity.

The computing device receives suggested content to present in a new slide of a presentation document (step 201). In an implementation, an application executing on the computing device, such as a presentation application, receives content generated in response to a request from a user. A presentation document of a presentation application includes a file (e.g., PPTX file) that contains one or more slides; slides in a presentation document may include a layout for presenting different types of content and may be designed according to a theme. A slide of a presentation may be a self-contained unit (e.g., a page) for presenting information, for example, as a part of a sequence of content presented in a slide presentation. To generate the suggested content, the application prompts a generative AI model to generate content for a slide presentation based on a request from the user. The request from the user may be a natural language input entered in a chat interface of the application, or the model may generate the suggested content based on information provided by the user, e.g., a document uploaded to the application. To obtain the generation of the suggested content, the application may execute an application assistant which interfaces with or includes a generative AI model to generate or suggest slide content. The generative AI model, such as a large language model, may be pretrained or fine-tuned for generating slide content.

The prompt to the generative AI model from the application or application assistant for generating suggested content for a slide presentation may include rules or instructions which task the model with generating the slide content in accordance with a set of common or available slide layouts or in terms of the various types and combinations of placeholders that are available for holding the slide content (e.g., title placeholder, subtitle placeholder, text placeholder, content placeholder, image placeholder). The model may also be prompted to generate custom non-textual content for the slide presentation, such as icons, images, audio clips, or video clips. Other rules provided to the AI model may include a minimum or maximum number of slides, a maximum number of words per slide, and the like. The prompt may also instruct the model to return the content in a parse-able format, such as encoded in XML or in a PPTX file.

In some scenarios, the suggested content received by the application has been manually created. For example, the user may be creating a slide presentation in the application by adding content to the slides, such as text boxes, logos, images, etc., using the formatting tools of the application. The suggested content may also be uploaded to the application by the user, such as content which was generated in another application (e.g., a browser application hosting a web interface to a generative AI model).

The computing device generates a new layout in accordance with which to present the suggested content in the new slide based on an existing layout (step 203). In an implementation, the application executes a design service to apply a template to the suggested slide content. The template may be one selected by the user in the application or it may be a default template. The template may include a number of slide layouts each of which is designed for a particular role in the presentation (e.g., title, agenda, conclusion) or which is structured for presenting certain types of content. For example, the suggested content may specify a title with a subtitle. The design service searches the template for a slide layout with placeholders for presenting title content and subtitle content. In searching or determining if an existing layout can present the suggested content, the design service may ignore some placeholders such as subtitles, headers, footers, slide numbering, and dates. In some cases, the design service may deem some types of placeholders to be equivalent to other types of placeholders. For example, a content placeholder may also be considered a multipurpose placeholder for text, image, video, and so on.

In particular, to search a template for a layout with which to present the suggested content of a slide, the design service may perform a rule-based search (e.g., to match placeholders to content elements); a matching algorithm the compares the structure of the suggested content to the placeholder structure of each available layout, ranking the layouts based on how well the content fits the placeholders. In still other scenarios, the design service may execute a heuristic search based on a decision tree algorithm where each branch represents a decision based on the content's characteristics leading to identifying the most suitable layout based on a series of content elements.

In some cases, the design service receives suggested content for which a new layout must be generated. For example, the template may not include a slide layout which will accommodate the suggested content of a slide. To apply a layout to the slide, the design service generates the new layout based on the slide content, that is to say, based on the various elements of the suggested content. To ensure that the new layout is consistent in style with the existing layouts of the template, the design service generates the new slide layout based on an existing layout, e.g., modifying or adapting an existing layout (“base layout”) to accommodate the suggested content. For example, if the suggested content requires an image placeholder and a text placeholder, the design service may select an existing layout and modify it according to rules or an algorithm for converting one type of layout to another. For example, where the structure of the base slide includes a title placeholder and a single content placeholder, the design service may modify the layout to allow for two text or content placeholders in place of the one content placeholder while maintaining the position and location of the title placeholder. Alternatively, the design service may bisect a placeholder to create two placeholders, where the size of each placeholder may be asymmetric or unequal (e.g., 70% text, 30% image) depending on the suggested content, allowing for a larger text placeholder and smaller image placeholder or vice versa based on the suggested content. Yet again, if the base layout is a blank slide, the design service may generate an appropriate layout for the suggested content by adding and positioning the necessary placeholders to the blank slide layout.

In modifying an existing layout to achieve the new layout, the design service may adhere to design rules which enforce, for example, a minimum placeholder size, prohibit or allow placeholders to overlap, switching the type of placeholder on the base slide, swapping the locations of placeholders on the base slide, or maintain a certain spacing between the placeholders. The design service may also apply design selections from a slide master of the templates such as minimum placeholder sizing, text properties, shape properties, font sizing, line spacing, font style and color, and so on. The design service may be further tasked to include or incorporate design elements of the base layout in the new layout, such as bars separating placeholders, iconography, or formatting specific to the type of placeholder (e.g., borders, text formatting). The design service may also generate variations on existing slide layouts by modifying design choices such as the arrangement or positioning of placeholders, varying font or text properties depending on the suggested content, and the like.

In some scenarios, the design service identifies multiple existing layouts to serve as base layouts for generating new layouts. The layouts may be identified based on a rule-based search, matching algorithm, or heuristic search (as described above). To generate the new layouts, each of the existing layouts identified for modification is then modified or adapted, e.g., according to design rules (as described above), which ensures visual consistency with the other layouts of the template.

The computing device merges the suggested content with the new layout to generate the new slide (step 205). In an implementation, the design service generates the slide presentation by merging the suggested content with existing layouts selected by the design service and new layouts generated by the design service. To merge the suggested content into a given layout, the design service adds the suggested content for the given layout to placeholders which are containers for receiving and holding the suggested content. For example, the text of a title of the suggested content for the given slide is added to a title placeholder of the given layout. When merging suggested content for a given slide into a newly created layout, the design service applies any design elements which are global to the existing layouts to the new layout. For example, the template for the slide presentation may include a slide master which contains elements which are inherited by the slide layouts of the template, such as a background design, logo, animation button, etc. The slide master may include text formatting information, such as a hierarchy of text styles which determines the text formatting for text or content placeholders. The design service applies the design elements of the slide master to the new slide to ensure visual consistency with the slides based on existing layouts of the template.

In scenarios where multiple new layouts are generated, the slide content is merged into each of the new layouts as well as each of the selected base layouts to create multiple new slides for the slide content. The multiple new slides are then ranked or ordered, for example, according to a heuristic based on design choices. The highest-ranking slide of the completed slides is then returned for inclusion on the presentation, and the remaining ones of the completed slides discarded.

Referring again to FIG. 1, operational environment 100 includes a brief example of process 200 as employed by elements of operational environment 100 in an implementation. In operational environment 100, computing device 110 executes application 120 including causing local user experiences 141(a) and 141(b) to be displayed via user interface 121. Application 120 may execute locally with respect to computing device 110, or computing device 110 may host application 120 which executes on one or more server computing devices remote from and in communication with computing device 110, or application 120 may execute in distributed, client-server fashion. User experiences 141(a) and 141(b) may include a chat interface by which the user can interact with application assistant 123 and, through application assistant 123, with a generative AI model for generating slide presentations.

In an operational scenario of operational environment 100, application 120 receives user input 142 via user interface 121 requesting a slide presentation document or file. Application 120 generates content for the slide presentation via an integration with a generative AI model, such as application assistant 123 which interfaces with a generative AI model for slide content generation.

Upon receiving the suggested content for a slide in the presentation, application 120 or an application assistant 123 calls design service 122 to design slide presentation 144, including generating a new layout in accordance with which to present the suggested content in a new slide. Design service 122 receives information relating to the suggested content of the slide, such as the elements of the slide which were specified for the slide in the suggested content. For example, the suggested content may include a title for the slide, a body of text, an image, and second body of text. To select a layout for the suggested content, design service 122 may search the layouts of template 130 for a particular type of layout. When design service 122 is unable to identify an existing layout for the slide, design service 122 selects an existing layout of template 130 to be modified to create a new layout. In some cases, to select a base slide for the new layout, design service 122 may rank the layouts of template 130 based on the structure or arrangement of placeholders to identify a most similar layout to the desired layout or a generic layout which can be adapted to generate a new layout.

Design service 122 generates new layout 133 based on modifying a layout of template 130 according to the elements of the suggested content, so the new layout will be visually consistent in theme with the other layouts of template 130. For example, as illustrated in FIG. 1, the slide layouts of template 130 have a common background design; so, too, does new layout 133 have the common background design. Design service 122 generates the new slide by merging the suggested content and new layout 133, then applying as necessary recurring design elements which are common or global to the layouts of template 130, such as design elements of a slide master of template 130.

In some scenarios, design service 122 identifies multiple existing layouts to be base layouts for creating new layouts. For example, multiple new layouts may be generated based on existing layouts which qualify (e.g., have sufficient placeholders) to receive the suggested content. Design service 122 may identify or select one or more existing layouts of template 130 which qualify or are suitable for displaying the suggested content or which are suitable for modification to generate new layouts. To identify qualified or suitable layouts, design service 122 may compare the placeholders in each of the existing layouts to the placeholders which would be necessary for displaying the suggested content. Alternatively, design service 122 may identify layouts which are suitable for modification, e.g., by adding or removing placeholders. With one or more base layouts identified, design service 122 generates new layouts based on each of the base layouts. The slide content is then merged into the new layouts and the base layouts to form completed slides. The completed slides are then ranked to determine the best slide for the suggested content. The highest ranking (i.e., best layout for the suggested content) is then returned for use in the presentation.

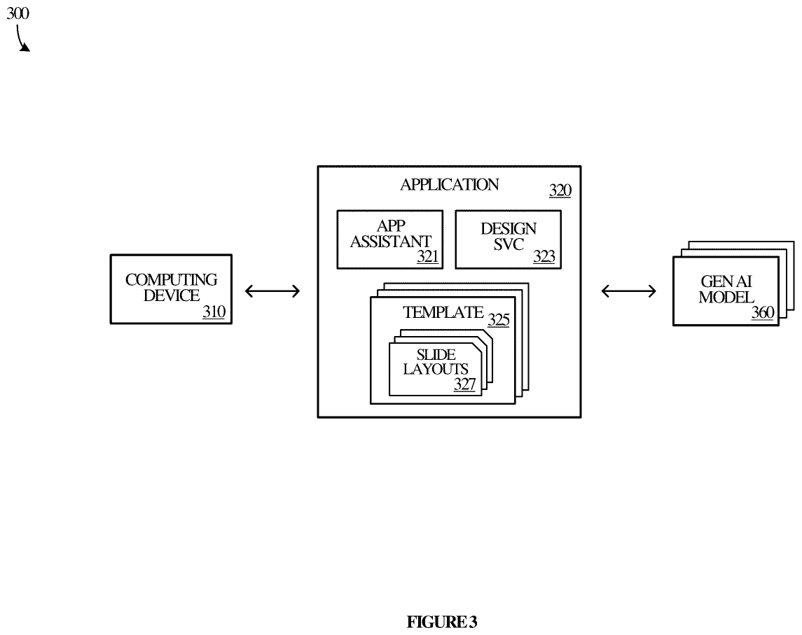

Turning now to FIG. 3, FIG. 3 illustrates operational architecture 300 for automated design and generation of slide layouts for presentation applications in an implementation. Operational architecture 300 includes computing device 310, application 320, and one or more generative AI models of which generative AI models 360 are representative. Application 320 includes application assistant 321, design service 323, and one or more templates of which template 325 is representative. Template 325 includes slide layouts 327.

Computing device 310 is representative of a computing device, such as a laptop or desktop computer, or mobile computing device, such as a tablet computer or cellular phone, of which computing system 601 in FIG. 6 is broadly representative. Computing device 310 communicates with application 320 via one or more internets and intranets, the Internet, wired or wireless networks, local area networks (LANs), wide area networks (WANs), and any other type of network or combination thereof. A user interacts with application 320 via a user interface of the application displayed on computing device 310.

Application 320 is representative of a software application for creating and editing slides for slide presentations or slide decks, of which application 120 is representative. Application 320 may be a presentation application, such as Microsoft® PowerPoint®, Apple® Keynote®, or Google® Slides, but can also include other kinds of productivity applications providing functionality for slide creation or the creation of other types of documents which include content elements arranged in structured layouts. Application 320 may execute on one or more servers in communication with computing device 310 over one or more wired or wireless connections. In some scenarios, application 320 executes in a distributed fashion, with a combination of client-side and server-side processes, services, and sub-services. For example, the core logic of application 320 may execute on a remote server system with a user interface of the application displayed on computing device 310.

Application 320 executing locally with respect to computing device 310 may execute in a stand-alone manner, within the context of another application such as a browser application, or in some other manner entirely. In an implementation, application 320 hosted by a remote application service runs locally with respect to computing device 310 as a natively installed and executed application, a browser-based application, a mobile application, a streamed application, or any other type of application. Application 320 running locally with respect to computing device 310 may interface with the remote application service and provide local user experiences displayed in a user interface on computing device 310.

Application assistant 321 is representative of a service or functionality by which a hosting application such as application 320 interfaces with a generative AI model of generative AI models 360, including mediating dialog between a user and the model and automating actions in the hosting application based on a user query. A generative AI model integration via application assistant 321 may provide semantic understanding of users'natural language inputs to assist the user in using the application, to make recommendations to the user with respect to content development or application use to users, and to facilitate activity within the application, such as generating suggested content for a slide presentation. For example, a user can seek assistance with content development, application usage, and other topics by submitting a natural language query, keyed in or spoken, in a chat pane of application assistant 321 and receive output from a model of generative AI models 360 which resolves the user's query. A user may also submit a query which causes application assistant 321 to perform an action in the application based on output generated by the model in response to the query. Application assistant 321 may be an application or service which hosts an API by which an application, such as application 320, transmits requests or queries for prompts to a model of generative AI models 360 and receives output generated by the model in response to the prompts. Alternatively, application assistant 321 may be a functionality hosted by application 320.

In an implementation, application assistant 321 enables an integration of generative AI model 360 with application 320. For example, application assistant 321 generates prompts based on a user query for submission to a model of generative AI models 360, receives output from the model based on the prompts, and formats the output for display in the user interface of the application. In some scenarios, application assistant 321 may access a model of generative AI models 360 which has been fine-tuned for a specific domain or application based on application-or task-specific data.

Design service 323 of application 320 is representative of a service or functionality of an application such as application 320 for designing slide presentations based on a template, such as template 325. For example, design service 323 may surface suggestions for slide designs to a user as the user is creating a slide in a user interface on computing device 310. Design service 323 may apply slide layouts of a user-selected template to a slide presentation hosted by application 320 and generate new slide layouts for presenting slide content. In various implementations, design service 323 interfaces with or includes an AI model, such as a model of generative AI models 360, to generate custom elements of a slide, such as custom imagery.

Template 325 is representative of a library of layouts such as layout 327 which have common theme. The theme of template 325 includes design elements (e.g., color scheme) and formatting rules (e.g., font style, placeholder spacing) which are applied to each of layouts in template 325 to ensure visual consistency of the slides. Each of the slide layouts includes a structure which defines an arrangement of placeholders which indicate a position or location on the layout and area of the layout for presenting different types of content, such as text, images, graphics, charts, tables, audio clips, video clips, cameos, titles, subtitles, headers, footers, and so on. Slide layouts of template 325 may also include design elements such as dividers (e.g., bars, lines) and icons. Various placeholders of slide layouts 327 of template 325 may include formatting information, such as font or text formatting attributes, depending on the role of or content held by the placeholder on the slide (e.g., a title placeholder may specify a larger font size). Template 325 may also include a slide master (not shown) including design elements which are thematic or global to slide layouts 327 of template 325, such as a background design, a color scheme, a font scheme, graphics such as icons and logos, header/footer information, and so on.

Generative AI models 360 are representative of one or more deep learning models trained in content generation, such as a generative pretrained transformer (GPT) computing model or architecture, e.g., Dall-E or GPT-4/4V. Various ones of generative AI models 360 may be pretrained or fine-tuned for tasks such as content generation for slide presentations or slide design and layout generation. Various models of generative AI models 360 may be hosted by computing services which provide the means by which application 320 or its services can communicate with a given model, such as an application programming interface (API). In communicating with application 320, generative AI models 360 may send and receive information (e.g., prompts and replies to prompts) in data objects, such as JavaScript Object Notation (JSON) objects. Generative AI models 360 may be implemented in the context of one or more server computers co-located or distributed across one or more data centers. In various implementations, generative AI models 360 may be pretrained or fine-tuned to generate output responsive to the prompts received from application 320, application assistant 321, or design service 323 for tasks such as content generation for slide presentations.

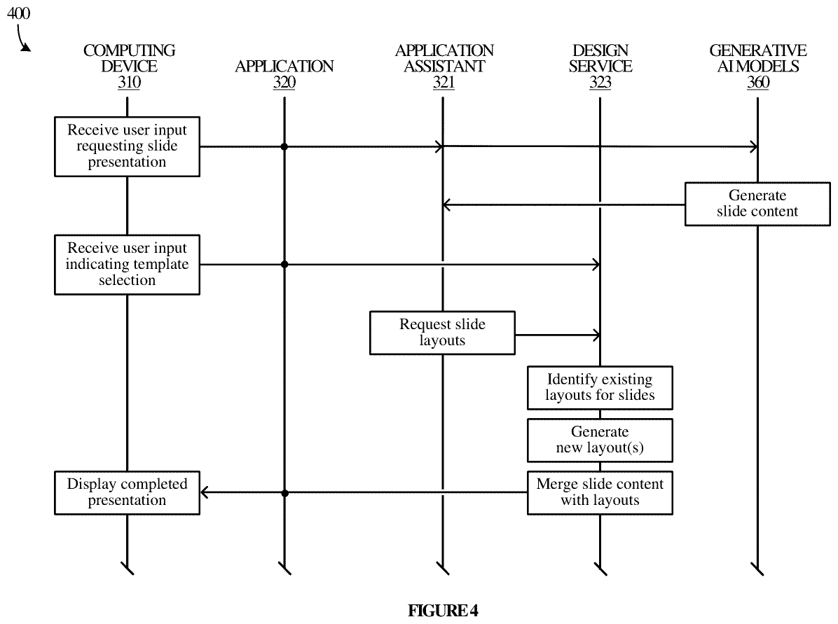

FIG. 4 illustrates workflow 400 for designing and generating custom slide layouts in an implementation and in reference to elements of operational architecture 300. In workflow 400, a user enters a natural language input in a user interface of application 320. The natural language input includes an intent by the user to create or have generated a slide presentation with content such as text, images, and the like. Application assistant 321 receives the user input and prompts a model of generative AI models 360 to suggest content for a slide presentation which is responsive to the user's request. The model returns slide content which defines a slide presentation including suggested content for multiple slides. Per the instructions provided to the model, the suggested content may include bodies or elements of text, images, graphics, charts, tables, etc. The suggested content may also be organized in terms of content for individual slides and in accordance with a particular slide layout (e.g., a title slide, a content slide with an image, etc.). Application 320 may also receive user input indicating a selection of a template, e.g., template 325, for the design of the requested presentation. In some scenarios, however, the template may be default template or one that is selected by, for example, design service 323.

With suggested content received from a model of generative AI models 360, application 320 sends the suggested content (e.g., in a PPTX file generated by the model) for the slide presentation to design service 323. Design service 323 merges the content to slide layouts 327 of template 325 to create the presentation document. To merge the content, design service 323 searches slide layouts 327 to identify a layout having the appropriate number and type of content containers with which to present the suggested content of each of the to-be-created slides. In some scenarios, design service 323 attempts to match elements of the suggested content to placeholders of the layouts of slide layouts 327 to identify a suitable layout.

Continuing with workflow 400, when design service 323 is unable to identify a layout of slide layouts 327 for the suggested content of a given slide, design service 323 creates a new layout, structuring the new layout to present the suggested content by including the appropriate number and type of placeholders for the different elements of the suggested content. Design service 323 generates a structure or arrangement of the placeholders in way that is consistent with existing ones of slide layouts 327 by modifying a selected layout of template 325.

Having generated a new layout for the suggested content based on an existing layout, design service 323 generates the slide presentation by merging the layouts with the suggested content for each slide. To merge the layouts with the suggested content, design service 323 may insert the elements of the suggested content into placeholders of the layout identified for the slide. Design service 323 may also apply other design elements to the newly generated slides, such as thematic elements or recurring elements from template 325 (e.g., design elements of a slide master). With the slide presentation completed, design service 323 returns the completed slide deck to application 320 which surfaces the slide deck in the user interface of the application at computing device 310.

In some implementations, for the suggested content of a given slide, the process of layout generation and merger is performed multiple times. For example, for a given slide, multiple potential slide layouts may be generated based on existing ones of slide layouts 327, and the best or optimal layout is identified. To identify an optimal layout, the suggested content is merged with each of the multiple layouts and the existing ones of slide layouts 327, and the layouts are ranked based on their display of the merged content. The optimal layout together with the merged content is then included in the slide presentation.

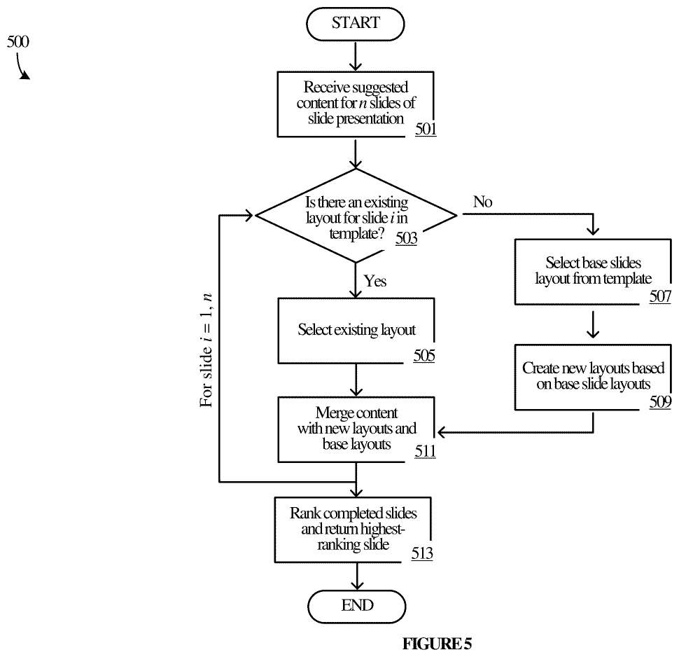

FIG. 5 depicts workflow 500 for identifying layouts for slides of slide presentation based on a template in an implementation. Workflow 500 may be performed by an application, such as application 120 of FIG. 1, in the context of generating a slide presentation based on content suggested by a generative AI model or created by a user. In some scenarios, workflow 500 may be performed by a design service of the application which communicates with the application to provide existing or newly generated slide layouts for slide content.

Workflow 500 begins with the application receiving suggested content for n slides of a slide presentation (step 501). The suggested content, encoded in XML, may include visual elements for each slide, such as text, images, graphics, and the like. To generate the slide presentation based on the suggested content, the application may execute a design service to apply a template to the content, such as a template selected by the user. The template may include different kinds of slide layouts which configure the slide content according to the type of slide, such as title slide, an agenda slide, a content slide, a transition slide, etc. The slide layouts may include multiple different kinds of placeholders where slide content can be added or inserted. For example, a content slide may have a title placeholder to receive title content and text placeholder to receive a portion of text.

The design service executed by the application determines whether there is an existing layout in the template for a given slide of the slides of the slide presentation (step 503). For the given slide, the design service searches the existing layouts for a structure with the appropriate number and type of placeholders to receive the suggested content. When a layout is identified by the design service, the design service then selects that layout for the slide (step 505).

If the design service does not identify an existing layout for the given slide, the design service selects base slide layouts from the template to create new layouts (step 507). The design service identifies or selects one or more existing layouts from the template which qualify or are suitable for modification to generate new layout. The design service may identify a particular type of layout, such as layouts with a basic set of placeholders, on which to base the creation of new layouts. For example, the content of the given slide may specify elements for populating a title placeholder and two content placeholders. If the template does not include a layout with the indicated placeholders, the design service may search for other types of layout structures, such as a title placeholder and single content placeholder, on which to generate new layouts. In some scenarios, to identify qualifying layouts, the design service may compare the placeholders in the existing layouts to the placeholders needed for displaying the suggested content.

When base layouts have been identified from among the existing layouts in the template, the design service creates new layouts (step 509). To create the new layouts, the design service may modify the base layouts according to rules or instructions for modifying the structure of an existing layout, such as repartitioning areas of the slide to receive a different number of content placeholders, changing the arrangement of placeholders (e.g., adding or removing placeholders) to create variation in slide designs, modifying font or text design choices based on the suggested content, and so on. In creating a new layout from a base layout, the design elements and formatting rules (i.e., theme) of the base layout are also applied to the new layout. Thus, the new layout will have a consistent visual appearance with the other existing layouts of the template.

With new layouts created, the design service merges the slide content with the base layouts and the newly generated layouts to create slides (step 511). The slides created from merging the slide content with each of the new layouts and the base layouts are then ranked to determine the best layout for the suggested content. In this way, the design service determines if an existing layout is really the best way to display the slide content, or if in fact a new layout is the better approach, enabling optimization in slide design. The highest ranking or best slide of the completed slides is returned or kept for use in the presentation (step 513). The process of slide generation continues for each of the slides in the slide presentation, with some slides created using existing layouts and some slides created using newly generated layouts.

FIG. 6 illustrates computing device 601 that is representative of any system or collection of systems in which the various processes, programs, services, and scenarios disclosed herein may be implemented. Examples of computing device 601 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing device 601 may be implemented as a single apparatus, system, or device or may be implemented in a distributed manner as multiple apparatuses, systems, or devices. Computing device 601 includes, but is not limited to, processing system 602, storage system 603, software 605, communication interface system 607, and user interface system 609 (optional). Processing system 602 is operatively coupled with storage system 603, communication interface system 607, and user interface system 609.

Processing system 602 loads and executes software 605 from storage system 603. Software 605 includes and implements slide layout process 606, which is (are) representative of the slide layout processes discussed with respect to the preceding Figures, such as process 200 and workflows 400 and 500. When executed by processing system 602, software 605 directs processing system 602 to operate as described herein for at least the various processes, operational scenarios, and sequences discussed in the foregoing implementations. Computing device 601 may optionally include additional devices, features, or functionality not discussed for purposes of brevity.

Referring still to FIG. 6, processing system 602 may comprise a micro-processor and other circuitry that retrieves and executes software 605 from storage system 603. Processing system 602 may be implemented within a single processing device but may also be distributed across multiple processing devices or sub-systems that cooperate in executing program instructions. Examples of processing system 602 include general purpose central processing units, graphical processing units, application specific processors, and logic devices, as well as any other type of processing device, combinations, or variations thereof.

Storage system 603 may comprise any computer readable storage media readable by processing system 602 and capable of storing software 605. Storage system 603 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 603 may also include computer readable communication media over which at least some of software 605 may be communicated internally or externally. Storage system 603 may be implemented as a single storage device but may also be implemented across multiple storage devices or sub-systems co-located or distributed relative to each other. Storage system 603 may comprise additional elements, such as a controller, capable of communicating with processing system 602 or possibly other systems.

Software 605 (including slide layout process 606) may be implemented in program instructions and among other functions may, when executed by processing system 602, direct processing system 602 to operate as described with respect to the various operational scenarios, sequences, and processes illustrated herein. For example, software 605 may include program instructions for implementing a slide layout design and generation process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 605 may include additional processes, programs, or components, such as operating system software, virtualization software, or other application software. Software 605 may also comprise firmware or some other form of machine-readable processing instructions executable by processing system 602.

In general, software 605 may, when loaded into processing system 602 and executed, transform a suitable apparatus, system, or device (of which computing device 601 is representative) overall from a general-purpose computing system into a special-purpose computing system customized to support slide layout design and generation in an optimized manner. Indeed, encoding software 605 on storage system 603 may transform the physical structure of storage system 603. The specific transformation of the physical structure may depend on various factors in different implementations of this description. Examples of such factors may include, but are not limited to, the technology used to implement the storage media of storage system 603 and whether the computer-storage media are characterized as primary or secondary storage, as well as other factors.

For example, if the computer readable storage media are implemented as semiconductor-based memory, software 605 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 607 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 601 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

### EXAMPLES

The following illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this Specification. As used below, any reference to a series of examples is to be understood as a reference to each of those examples disjunctively (e.g., “Examples 1-4” is to be understood as “Examples 1, 2, 3, or 4”).

Example 1 is a computing apparatus comprising: one or more computer readable storage media; one or more processors operatively coupled with the one or more computer readable storage media; and program instructions stored on the one or more computer readable storage media that, when executed by the one or more processors, direct the computing apparatus to: receive suggested content to present in a new slide of a presentation document having a theme defined by a template associated with the presentation document; generate a new layout in accordance with which to present the suggested content in the new slide based on an existing layout of the template; and merge the suggested content with the new layout to generate the new slide.

Example 2 is the computing apparatus of any previous or subsequent example, wherein the program instructions further direct the computing apparatus to: search one or more existing layouts defined by the template for a layout comprising a structure that matches the suggested content of the new slide; and determine that the template does not include the layout comprising a structure that matches the suggested content for the new slide.

Example 3 is the computing apparatus of any previous or subsequent example, wherein to generate the new layout, the program instructions direct the computing apparatus to: identify one or more existing layouts of the template for receiving the suggested content; generate one or more new layouts based on the one or more existing layouts; determine a ranking of the one or more existing layouts and the one or more new layouts; and select the new layout based on the ranking.
Example 4 is the computing apparatus of any previous or subsequent example, wherein to generate the new layout, the program instructions direct the computing apparatus to modify a structure of the existing layout based at least on the suggested content.
Example 5 is the computing apparatus of any previous or subsequent example, wherein to modify the structure of the existing layout, the program instructions direct the computing apparatus to add one or more placeholders to the existing layout based on elements of the suggested content, wherein a placeholder of the one or more placeholders comprises a container for holding the suggested content.
Example 6 is the computing apparatus of any previous or subsequent example, wherein the new layout comprises content formatting information, content positioning information, and one or more placeholders for receiving slide content.
Example 7 is the computing apparatus of any previous or subsequent example, wherein the theme comprises design elements and formatting rules which determine a visual appearance of the new slide.
Example 8 is a method of operating a computing device comprising: receiving suggested content to present in a new slide of a presentation document having a theme and one or more existing layouts defined by a template associated with the presentation document; generating a new layout in accordance with which to present the suggested content in the new slide based on a slide layout of the template; and merge the suggested content with the new layout to generate the new slide.
Example 9 is the method of any previous or subsequent example, further comprising: searching one or more existing layouts defined by the template for a layout comprising a structure that matches the suggested content of the new slide; and determining that the template does not include the layout comprising a structure that matches the suggested content for the new slide.
Example 10 is the method of any previous or subsequent example, generating the new layout comprises: identifying one or more existing layouts of the template for receiving the suggested content; generating one or more new layouts based on the one or more existing layouts; determining a ranking of the one or more existing layouts and the one or more new layouts; and selecting the new layout based on the ranking.
Example 11 is the method of any previous or subsequent example, wherein generating the new layout comprises modifying a structure of the existing layout based at least on the suggested content.
Example 12 is the method of any previous or subsequent example, wherein modifying the structure of the existing layout comprises adding one or more placeholders to the existing layout based on elements of the suggested content, wherein a placeholder of the one or more placeholders comprises a container for holding the suggested content.
Example 13 is the method of any previous or subsequent example, wherein the new layout comprises content formatting information, content positioning information, and one or more placeholders for receiving slide content.
Example 14 is the method of any previous or subsequent example, wherein the theme comprises design elements and formatting rules which determine a visual appearance of the new slide.
Example 15 is one or more computer readable storage media having program instructions stored thereon that, when executed by one or more processors, direct a computing apparatus to at least: receive suggested content to present in a new slide of a presentation document having a theme defined by a template associated with the presentation document; generate a new layout in accordance with which to present the suggested content in the new slide based on an existing layout of the template; and merge the suggested content with the new layout to generate the new slide.
Example 16 is the one or more computer readable storage media of any previous or subsequent example, The computing apparatus of any previous or subsequent example, wherein the program instructions further direct the computing apparatus to: search one or more existing layouts defined by the template for a layout comprising a structure that matches the suggested content of the new slide; and determine that the template does not include the layout comprising a structure that matches the suggested content for the new slide.
Example 17 is the one or more computer readable storage media of any previous or subsequent example, wherein to generate the new layout, the program instructions direct the computing apparatus to: identify one or more existing layouts of the template for receiving the suggested content; generate one or more new layouts based on the one or more existing layouts; determine a ranking of the one or more existing layouts and the one or more new layouts; and select the new layout based on the ranking.
Example 18 is the one or more computer readable storage media of any previous or subsequent example, wherein to generate the new layout, the program instructions direct the computing apparatus to modify a structure of the existing layout based at least on the suggested content.
Example 19 is the one or more computer readable storage media of any previous or subsequent example, wherein to modify the structure of the existing layout, the program instructions direct the computing apparatus to add one or more placeholders to the existing layout based on elements of the suggested content, wherein a placeholder of the one or more placeholders comprises a container for holding the suggested content.
Example 20 is the one or more computer readable storage media of any previous or subsequent example, wherein the new layout comprises content formatting information, content positioning information, and one or more placeholders for receiving slide content.

What is claimed is:

1. A computing apparatus comprising:
one or more computer readable storage media;
one or more processors operatively coupled with the one or more computer readable storage media; and
program instructions stored on the one or more computer readable storage media that, when executed by the one or more processors, direct the computing apparatus to:
receive suggested content to present in a new slide of a presentation document having a theme defined by a template associated with the presentation document;
generate a new layout in accordance with which to present the suggested content in the new slide based on an existing layout of the template; and
merge the suggested content with the new layout to generate the new slide.

2. The computing apparatus of claim 1, wherein the program instructions further direct the computing apparatus to:
search one or more existing layouts defined by the template for a layout comprising a structure that matches the suggested content of the new slide; and
determine that the template does not include the layout comprising a structure that matches the suggested content for the new slide.

3. The computing apparatus of claim 1, wherein to generate the new layout, the program instructions direct the computing apparatus to:
identify one or more existing layouts of the template for receiving the suggested content;
generate one or more new layouts based on the one or more existing layouts;
determine a ranking of the one or more existing layouts and the one or more new layouts; and
select the new layout based on the ranking.

4. The computing apparatus of claim 1, wherein to generate the new layout, the program instructions direct the computing apparatus to modify a structure of the existing layout based at least on the suggested content.

5. The computing apparatus of claim 4, wherein to modify the structure of the existing layout, the program instructions direct the computing apparatus to add one or more placeholders to the existing layout based on elements of the suggested content, wherein a placeholder of the one or more placeholders comprises a container for holding the suggested content.

6. The computing apparatus of claim 1, wherein the new layout comprises content formatting information, content positioning information, and one or more placeholders for receiving slide content.

7. The computing apparatus of claim 1, wherein the theme comprises design elements and formatting rules which determine a visual appearance of the new slide.

8. A method of operating a computing device comprising:
receiving suggested content to present in a new slide of a presentation document having a theme and one or more existing layouts defined by a template associated with the presentation document;
generating a new layout in accordance with which to present the suggested content in the new slide based on a slide layout of the template; and
merge the suggested content with the new layout to generate the new slide.

9. The method of claim 8, further comprising:
searching one or more existing layouts defined by the template for a layout comprising a structure that matches the suggested content of the new slide; and
determining that the template does not include the layout comprising a structure that matches the suggested content for the new slide.

10. The method of claim 8, generating the new layout comprises:
identifying one or more existing layouts of the template for receiving the suggested content;
generating one or more new layouts based on the one or more existing layouts;
determining a ranking of the one or more existing layouts and the one or more new layouts; and
selecting the new layout based on the ranking.

11. The method of claim 8, wherein generating the new layout comprises modifying a structure of the existing layout based at least on the suggested content.

12. The method of claim 11, wherein modifying the structure of the existing layout comprises adding one or more placeholders to the existing layout based on elements of the suggested content, wherein a placeholder of the one or more placeholders comprises a container for holding the suggested content.

13. The method of claim 8, wherein the new layout comprises content formatting information, content positioning information, and one or more placeholders for receiving slide content.

14. The method of claim 8, wherein the theme comprises design elements and formatting rules which determine a visual appearance of the new slide.

15. One or more computer readable storage media having program instructions stored thereon that, when executed by one or more processors, direct a computing apparatus to at least:
receive suggested content to present in a new slide of a presentation document having a theme defined by a template associated with the presentation document;
generate a new layout in accordance with which to present the suggested content in the new slide based on an existing layout of the template; and
merge the suggested content with the new layout to generate the new slide.

16. The one or more computer readable storage media of claim 15, wherein the program instructions further direct the computing apparatus to:
search one or more existing layouts defined by the template for a layout comprising a structure that matches the suggested content of the new slide; and
determine that the template does not include the layout comprising a structure that matches the suggested content for the new slide.

17. The one or more computer readable storage media of claim 15, wherein to generate the new layout, the program instructions direct the computing apparatus to:
identify one or more existing layouts of the template for receiving the suggested content;
generate one or more new layouts based on the one or more existing layouts;
determine a ranking of the one or more existing layouts and the one or more new layouts; and
select the new layout based on the ranking.

18. The one or more computer readable storage media of claim 15, wherein to generate the new layout, the program instructions direct the computing apparatus to modify a structure of the existing layout based at least on the suggested content.

19. The one or more computer readable storage media of claim 18, wherein to modify the structure of the existing layout, the program instructions direct the computing apparatus to add one or more placeholders to the existing layout based on elements of the suggested content, wherein a placeholder of the one or more placeholders comprises a container for holding the suggested content.

20. The one or more computer readable storage media of claim 15, wherein the new layout comprises content formatting information, content positioning information, and one or more placeholders for receiving slide content.
